(19) United States
(12) Patent Application Publication
(10) Pub. No.: US 2003/0106190 A1
(43) Pub. Date: Jun. 12, 2003

(54) Button locking carabiner

(76) Inventor: Tony Christianson, Yosemite, CA (US)

Correspondence Address: Tony Christianson, 2007 Wawona Station, Yosemite, CA, 95389, US

(21) Appl. No.: 10/309,599

(22) Filed: Dec. 3, 2002

Related U.S. Application Data
(60) Provisional application No. 60/339,524, filed on Dec. 8, 2001.

(51) Int. Cl. F16B 45/02

(52) U.S. Cl. 24/600.1; 24/599.1

(57) ABSTRACT

The instant invention is a compact carabiner locking mechanism contained within the carabiner gate. The locking mechanism incorporates a means to block movement of the gate return spring mechanism and subsequent movement of the gate. A low profile external button is pushed to unblock the gate return spring mechanism, which enables the gate to be opened. The button is recessed to prevent inadvertent activation. Furthermore, the button is located so that the carabiner gate can be conveniently unlocked, opened and relocked with one hand.

### RELATED PROVISIONAL APPLICATIONS AND DISCLOSURE DOCUMENTS

The instant invention is related to Provisional Application No. 60/339,524 filed Dec. 8, 2001; and now abandoned Provisional Applications No. 60/295,681 filed Jun. 2, 2001 and No. 60/197,745 filed Apr. 17, 2000. The instant application is also related to Disclosure Document No. 500828 deposited Oct. 5, 2001; and Disclosure Document No. 456950 deposited May 25, 1999.

### BACKGROUND OF THE INVENTION

1. Field of the Invention

The instant invention is generally related to climbing aids for rock climbers. More particularly, this invention is related to mechanical devices that link climbing aids together.

2. Description of the Prior Art

Climbers utilize rope, slings and a variety of mechanical devices as climbing aids to assist and protect their movement over rock. The climbing aids serve as a means to anchor the climber to the rock for the purpose of either preventing or arresting a fall.

A carabiner is a mechanical device used to link rope, slings and other climbing aids together. A carabiner is essentially a snap-hook used, for example, to attach a climber's body harness to the climbing rope. It is also used to link the climbing rope to anchors placed in or over the rock.

A typical carabiner is a palm sized, oblong or oval or “D” shaped ring of a lightweight, high strength material, usually a heat-treated aluminum alloy. One side of the carabiner has a hinged arm that serves as an inward opening gate. The gate is spring loaded to remain normally closed.

The normally closed, inward opening gate facilitates insertion of climbing aids, but impedes inadvertent removal. Objects are released from the carabiner after manually pushing open the gate.

The closing force is provided by a stout compression spring that is housed within the carabiner gate. The spring axis is offset from the pivot pin so that the spring force is directed to close the gate. A link is employed to transfer the spring force to the carabiner body at an appropriate distance from the pivot pin.

The opening end of the gate incorporates a transverse pin that engages a hooked notch in the carabiner body when the gate is completely closed. This arrangement allows the gate to carry part of the load imposed on the carabiner. Consequently, the carabiner is significantly stronger when the gate is closed. The ultimate strength of a carabiner with the gate open is typically 65% lower than with the gate closed.

During a climb and especially in the event of a fall, the climber's safety is dependent on the security of numerous carabiner links. Consequently, it is imperative that every carabiner in the chain be able to withstand not only the weight of the climber but also the inertial forces generated when the rope arrests a fall.

As the climber progresses, the carabiners in a protective chain of climbing aids often rub against the rock. Occasionally, a carabiner gate will catch on a rock or other object and may be pushed open without the climber's knowledge. Also, during a fall a carabiner will often slap against the rock causing inertial loads that overcome the closing force of the spring and momentarily open the gate.

Whenever the gate opens, even momentarily, there is significant risk that a rope or other climbing aid will be inadvertently released. Furthermore, if a sudden load is applied to the carabiner at the instant that the gate is open, the ultimate strength of the carabiner is significantly compromised and very possibly may fail. Such occurrences are well known by the climbing community and are considered a major problem.

Greater security can be obtained by using two carabiners in parallel with the gates opening in opposite directions. However, extra carabiner for the purpose of parallel placement are undesirable because they add considerably to the weight and bulk that the climber must carry. Accordingly, various means have been developed to lock the carabiner gate closed.

A popular solution to the problem incorporates a locking sleeve that is threaded, nut like, to the gate. The sleeve can be screwed along the length of the gate, either toward the hinge, or toward the opening end. The sleeve is screwed into the locking position after the rope or other climbing aids have been clipped into the carabiner. In one configuration the gate is locked closed by screwing the sleeve until it crosses the opening end of the gate and jams against the adjacent body of the carabiner. In an alternate configuration the gate is immobilized when the sleeve is screwed over the hinge.

Unfortunately, threaded locking sleeves undesirably add bulk and weight to the carabiner. Threaded locking sleeves ire also inherently troublesome. The threads can become clogged with dirt or ice. The sleeve can inadvertently screw out of the locked position when the carabiner rubs across the rock. Furthermore, the gate and threaded sleeve mechanism require precise machining and assembly alignment, both of which add significantly to manufacturing cost.

Other solutions of the prior art include gates equipped with spring loaded sliding and/or rotary sleeves. Sliding and/or rotary sleeves function similarly to threaded sleeves. Sliding and rotary sleeves share the same problems as threaded sleeves, and are especially costly to manufacture.

The increased bulk, weight and cost of the prior art limits the number of locking carabiner that a climber is able to carry during a climb or is willing to buy in the first place. Consequently, there may be situations during a climb when the climber is compelled to use a non-locking carabiner although a locking type would be preferable or safer.

The instant invention is a carabiner incorporating a locking mechanism that securely and reliably locks the gate closed. The inventive locking mechanism is contained inside the gate; therefore it does not add bulk or weight to the carabiner and is less susceptible to jamming by dirt or ice. The gate can be unlocked, opened and relocked with one hand. In addition, compared to the prior art, the preferred configuration of the instant invention is significantly less costly to manufacture.

### SUMMARY OF THE INVENTION

The instant invention is a compact carabiner locking mechanism contained within the carabiner gate. The locking mechanism incorporates a means to block movement of the gate return spring mechanism and subsequent movement of the gate. A low profile external button is pushed to unblock the gate return spring mechanism, which enables the gate to be opened. The button is located so that the carabiner gate can be conveniently unlocked, opened and relocked with one hand.

### DESCRIPTION OF THE DRAWINGS

A detailed description of the invention is made with reference to the accompanying drawings wherein like numerals designate corresponding parts in the several FIGS.

FIG. 1 is a pictorial view of the inventive carabiner linking rope and webbing.

FIG. 2 is a side elevation view of a carabiner incorporating the preferred configuration of the inventive locking mechanism.

FIG. 3 is a top view of the carabiner as seen in the, direction 3-3 of FIG. 2.

FIG. 4 is a partial sectional view of the inventive carabiner, taken along a cut corresponding to line 4-4 of FIG. 3.

FIG. 5 is a partial close-up sectional view of the carabiner of FIG. 4.

FIG. 6 is a sectional view of the carabiner, taken along a cut corresponding to line 6-6 of FIG. 5.

FIG. 7 is a sectional view of the carabiner, taken along a cut corresponding to line 7-7 of FIG. 5.

FIG. 8 is a partial sectional view of the carabiner of FIG. 4, showing the locking mechanism unlocked.

FIG. 9 is a free-body diagram of the spring and link assembly in the locked position.

FIG. 10 is a free-body diagram of the spring and link assembly in the unlocked position.

FIG. 11 is a partial close-up sectional view of the carabiner of FIG. 8, showing the gate partially open.

FIG. 12 is a partial close-up sectional view of an alternate configuration of the inventive carabiner.

FIG. 13 is a partial close-up sectional view of another alternate configuration of the inventive carabiner.

FIG. 14 is a sectional view of the carabiner of FIG. 13, taken along a cut corresponding to line 14-14.

FIG. 15 is a sectional view of the carabiner of FIG. 13, taken along a cut corresponding to line 15-15.

FIG. 16 is a partial sectional view of the carabiner of FIG. 13, showing the locking mechanism unlocked just prior to opening the gate.

FIG. 17 is a partial close-up sectional view of the inventive carabiner of FIG. 16, showing the gate partially open.

FIG. 18 is a free-body diiagram of the spring and link assembly of the carabiner of FIG. 17.

FIG. 19 is a partial close-up sectional view of yet another alternate configuration of the inventive carabiner.

FIG. 20 is a sectional view of the carabiner, taken along a cut corresponding to line 20-20 of FIG. 19.

FIG. 21 is a partial sectional view of the carabiner of FIG. 19, showing the locking mechanism unlocked just prior to opening the gate.

FIG. 22 is a partial close-up sectional view of the inventive carabiner of FIG. 19, showing the gate partially open.

FIG. 23 is a partial close-up sectional view of yet another alternate configuration of the inventive carabiner.

FIG. 24 is a partial close-up sectional view of yet another alternate configuration of the inventive carabiner.

FIG. 25 is a sectional view of the carabiner of FIG. 24, taken along a cut corresponding to line 25-25 of FIG. 24.

FIG. 26 is a partial sectional view of the carabiner of FIG. 24, showing the locking mechanism unlocked just prior to opening the gate.

FIG. 27 is a partial close-up sectional view of another alternate configuration of the inventive carabiner, showing the gate partially open.

FIG. 28 is a partial close-up sectional view of yet another alternate configuration of the inventive carabiner, showing the locking mechanism unlocked just prior to opening the gate.

FIG. 29 is a partial close-up sectional view of yet another alternate configuration of the inventive carabiner.

FIG. 30 is a sectional view of the carabiner of FIG. 29, taken along a cut corresponding to line 30-30.

FIG. 31 is a partial sectional view of the carabiner of FIG. 29, showing the locking mechanism unlocked just prior to opening the gate.

FIG. 32 is a partial close-up sectional view of the carabiner of FIG. 29, showing the gate partially open.

FIG. 33 is a partial close-up sectional view of yet another alternate configuration of the inventive carabiner.

FIG. 34 is a sectionaI view of the inventive carabiner of FIG. 33, taken along a cut corresponding to line 34-34.

FIG. 35 is a partial close-up sectional view of the inventive carabiner of FIG. 33, showing the gate partially open.

FIG. 36 is a partial close-up sectional view of yet another alternate configuration of the inventive carabiner.

FIG. 37 is a top view of the carabiner of FIG. 3a seen in the direction 37-37.

FIG. 38 is a sectional view of the inventive carabiner of FIG. 36, taken along a cut corresponding to line 38-38.

FIG. 39 is a partial close-up sectional view of the inventive carabiner of FIG. 36, showing the gate partially open.

FIG. 40 is a pictorial view showing one hand unlocking the inventive locking mechanism and opening the gate.

FIG. 41 is a partial sectional view of a typical carabiner of the Prior Art.

### DESCRIPTION OF THE PREFERRED EMBODIMENT

The following detailed description is of the best presently contemplated modes of carrying out the invention. This description is not to be taken in a limiting sense, but is made merely for purposes of illustrating the general principles of the invention.

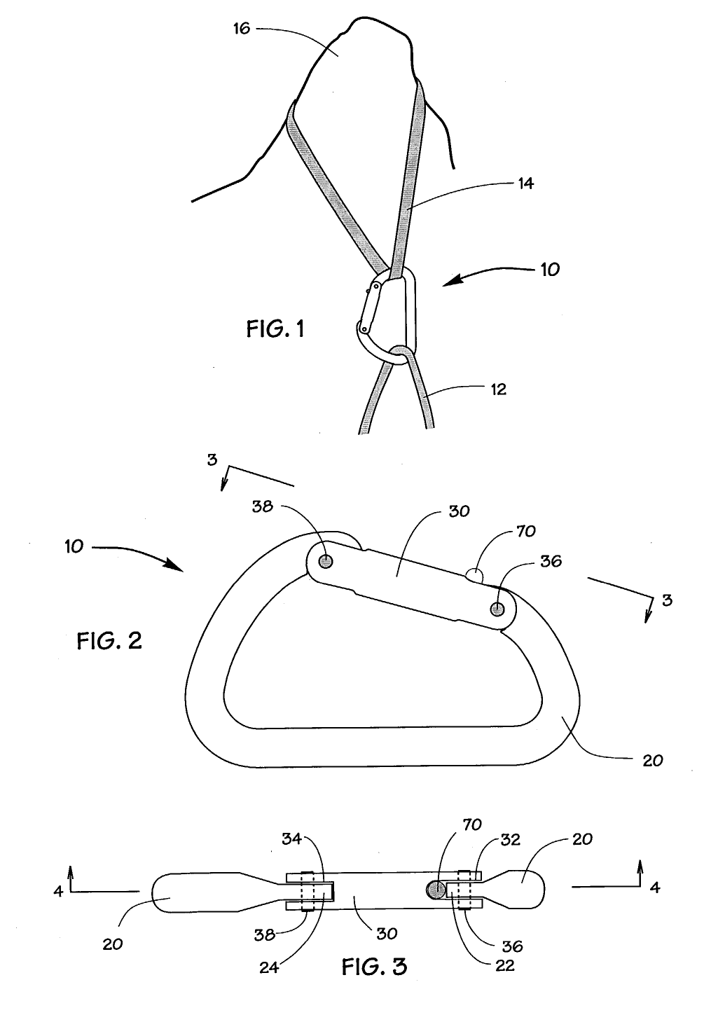

Referring to FIG. 1, inventive carabiner 10 is shown linking climbing rope 12 to webbing 14 looped around rock 16. FIG. 1 exemplifies one of the many ways that a carabiner can be used to link climbing aids together.

Referring to FIG. 2, carabiner 10 includes body 20 and gate 50. The inventive locking mechanism is contained within gate 50, only button 70 protrudes externally. Body 20 and gate 50 are fabricated from a lightweight, high strength material, for example aluminum alloy type 7075 heat treated to condition T6.

The simplest, and preferred, configuration of the inventive locking mechanism is illustrated by FIGS. 2-12.

Referring to FIG. 5, gate 50 is slotted at both ends by parallel slots 52 and 34. Leg ends 22 and 24 of body 20 nest loosely within the confines of slots 32 and 34 respectively. Gate 30 is hinged to body 20 by pin 36 which transverses slot 32 through a slip-fitting hole in leg end 22.

Referring to FIGS. 3, 4 and 5, the opening end of gate 30 includes pin 38 which transverses slot 34. When gate 30 is closed, pin 38 rests against the top of notch 28 in body 20, thereby limiting the closing movement of gate 30. Notch 28 also serves to capture pin 38 when high tensile loads deform bodily 20, thereby enabling gate 30 to carry part of the load transmitted through body 20.

Alternate means of limiting the travel of gate 30 are possible. For example, forming the end of gate 30 to abut directly against a mating recess of body 20 can eliminate pin 38. As another alternative, the end of gate 30 and the associated leg of body 20 can be formed or machined to provide an interlocking relationship that transmits tensile loads.

Referring to FIG. 5, gate 30 is held in the closed position by the combined action of compression spring 40, spring pin 50 and link 60. Compression spring 40 and spring pin 50 are loosely contained within hole 42. Hole 42 opens into slot 32 and the axis of hole 42 is approximately parallel to the axis of gate 30. As best seen in FIG. 6, hole 42 has an oblong cross section.

Compression spring 40 is typically fabricated by coiling a corrosion resistant material, for example 17-7 PH stainless steel spring wire. Machining or forcing a corrosion resistant material, for example brass, is a typical way to fabricate spring pin 50. Machining and swaying a corrosion resistant material, for example type 316 stainless steel wire, is a typical way to fabricate link 60.

Compression spring 40, in conjunction with spring pin 50, applies a force in one direction against abutment 44 in hole 42 and in the other direction against joint 62 between spring pin 50 and link 60. Link 60 transmits the force to notch 26 on body 20. Notch 26 is adjacent but offset inward from the center of hinge pin 36. The offset distance provides the leverage which forces gate 30 closed. When gate 30 opens, link 60 pushes spring pin 50 into hole 42, compressing spring 40. When gate 30 is open, the force of spring 40 against link 60 urges gate 30 to return to the closed position.

Referring again to FIGS. 3, 4 and 5, lock button 70 is located within slot 32 adjacent leg 22 of body 20. Lock button 70 transverses the width of gate 30. Referring to FIGS. 5 and 7, link 60 passes loosely through hole 72, which transverses lock button 70, thereby retaining lock button 70 within slot 32. The longitudinal axis of lock button 70 is approximately perpendicular to the longitudinal axis of gate 30, and intersects the longitudinal axis of hole 42. Sufficient clearance is provided between slot 32 and lock button 70 so that lock button 70 can move without binding.

Referring to FIG. 8, lock button 70 can be pushed either in or out as depicted by the outline arrows “A” and “B” respectively. Moving lock button 70 in one direction or the other pushes against link 60 at the location where link 60 passes through hole 72. One end of link 60 is restrained axially by notch 26, however link 60 is free to pivot around notch 26 thereby moving joint 62 between link 60 and spring pin 50.

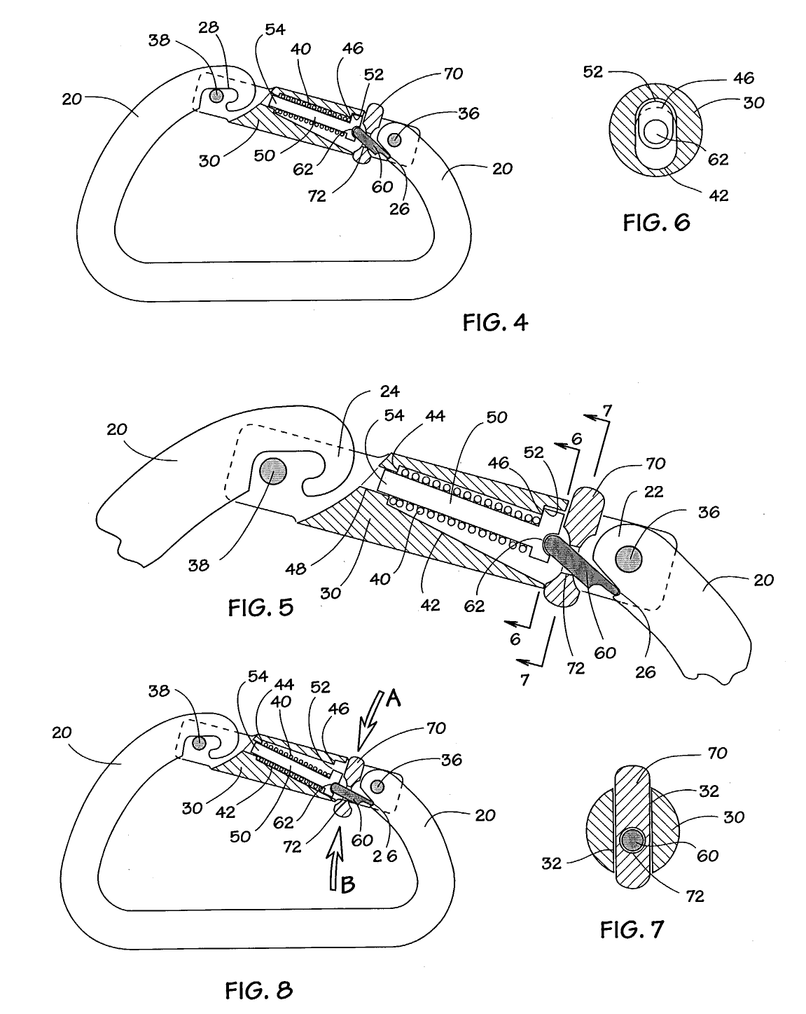

Moving button 70 in the direction of arrow “A” causes link 60, spring 40 and spring pin 50 to move to the unlocked position shown in FIG. 8. Moving lock button 70 in the direction of arrow “B” causes link 60, spring 40 and spring pin 50 to move to the locked position shown in FIGS. 4 and 5.

Referring to the locked position shown in FIGS. 4 and 5, shoulder 52 of spring pin 50 abuts shelf 46 in hole 42. The engagement of shoulder 52 with shelf 46 blocks the opening movement of spring pin 50 and thereby immobilizes gate 30.

Referring to the unlocked position shown in FIG. 8, the movement of button 70 in direction “A” has moved shoulder 52 away from shelf 46. Without the engagement of shoulder 52 with shelf 46, spring pin 50 is free to move axially within hole 42; therefore gate 30 can be opened as shown in FIG. 11. In FIG. 11, the outline arrow depicts the force opening gate 30.

Referring to FIG. 5, end 54 of spring pin 50 passes through hole 48 at the bottom of hole 42. Sufficient clearance is provided between spring pin 50 and hole 48 so that spring pin 50 can move axially without binding. The difference between the diameters of hole 42 and hole 48 provide abutment 44 for one end of spring 40. Hole 48 provides guidance for the axial movement of spring pin 40. Alternately, hole 48 can be eliminated, spring pin 50 shortened, and guidance of spring pin 50 provided by spring 40 itself.

The location of abutment 44 with respect to notch 26, and the dimensions of hole 42 are chosen to enable spring pin 50 and link 60 to have two stable positions, either locked or unlocked. As such, spring pin 50 and link 60 operate as an over-center switch that can be changed from one stable position to the other by moving button 70. Movement from the locked to the unlocked position, and the opposite, produces an audible “snap” that can be heard by the climber. In addition, the position of button 70, either up or down, provides a visual and tactile indication of the state of the inventive locking mechanism.

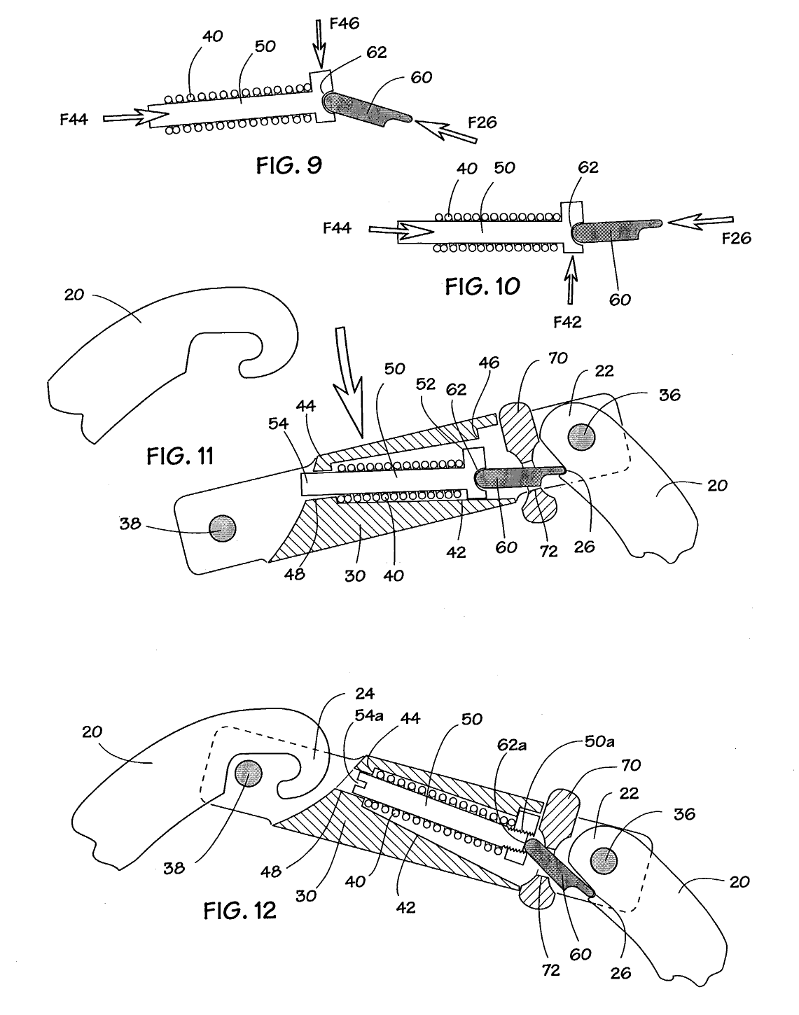

FIG. 9 is a free-body diagram of spring 40, spring pin 50 and link 60 showing the forces acting on the assembly when in the locked position. F44 is the force against spring 40 from abutment 44. F26 is the force against link 60 from notch 26. Because the forces F44 and F26 are offset upward when in the locked position, joint 62 between spring pin 50 and link 60 will buckle upward, which is resisted by F46 from shelf 46.

Similarly, FIG. 10 is a free-body diagram of spring 40, spring pin 50 and link 60 showing the forces acting on the assembly when in the unlocked position. F44 is the force against spring 40 from abutment 44. F26 is the force against link 60 from notch 26. Because the forces F44 and F26 are offset downward when in the unlocked position, joint 62 between spring pin 50 and link 60 will buckle downward, which is resisted by F42 from the sidewalI of hole 42.

Climbers are often in precarious positions in which only one hand is available to insert a climbing aid or rope into a carabiner (typically the other hand is occupied holding on to another climbing aid or the rock surface). Under such circumstances it may be imperative that the carabiner be easily unlocked and opened and subsequently relocked with only one hand. Because the inventive locking carabiner of FIGS. 3-12 has two stable positions, either locked or unlocked, and lock button 70 can be easily moved with one finger, a climber can first unlock the carabiner, open and close gate 30 as many times as need, and when appropriate, relock the carabiner, all with the use of one hand.

As described supra, when shoulder 52 engages shelf 46, gate 30 cannot move. For the inventive carabiner to be assembled and function properly, manufacturing tolerances must be controlled so that shoulder 52 lines-up with shelf 46 when gate 30 is closed. Referring to FIG. 12, the distance D61 of link 60 plus the shouldered portion of pin 50 must equal the distance between notch 26 and shelf 46 when gate 30 is closed. If link 60 is fabricated so that D61 is too short, some opening movement of gate 30 will occur even when shoulder 52 and shelf 46 are engaged. Conversely, if D61 is fabricated overlong, it will not be possible to engage shoulder 52 with shelf 46. These problems are avoided by the alternate configuration of FIG. 12.

FIG. 12 shows the configuration of FIG. 5, but spring pin 50 has been replaced by threaded rod 51 and nut 55. Nut 55 provides shoulder 52 that engages shelf 46. Threaded rod 51 and nut 55 are adjusted to compensate for dimensional variations of the various components. Screwing rod 51 in or out with respect to nut 55 adjusts the location of joint 62a, thereby lengthening or shortening distance D61 to precisely match the distance between shelf 46 and notch 26. Screwdriver slot 55 facilitates adjustment of D61 after the carabiner has been assembled.

During assembly of the inventive carabiner, threaded rod 51 is overly threaded into nut 53 to provide ample clearance between the various components. After the inventive carabiner is assembled, threaded rod 51 is screwed outward until shoulder 52 just makes contact with shelf 46. At the point when shoulder 52 makes contact with shelf 46, gate 30 will be unable to open unless lock button 70 is moved to the unlocked position.

Furthermore, other means of adjustment can be conceived. For example, the location of notch 26 can be adjusted by utilizing a setscrew, or the like, threaded at an angle into body 20 adjacent the proper location of notch 26 (see FIG. 23). This adjustment configuration will be described in more detail following.

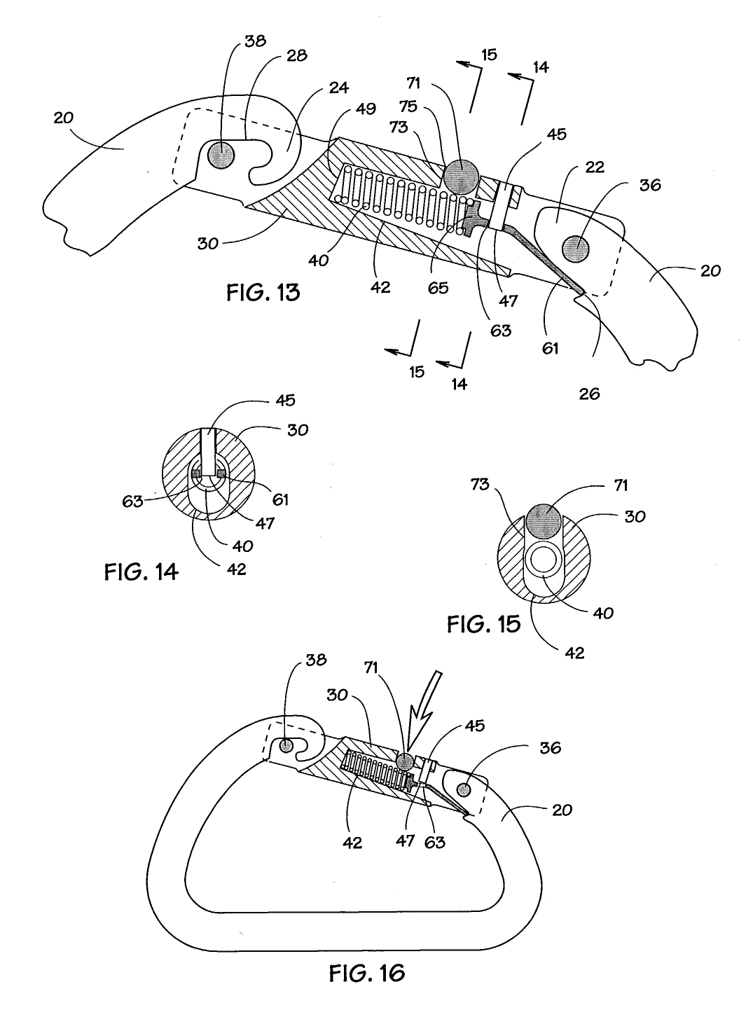

FIGS. 13-23 shows alternate configurations of the instant invention. Referring to FIG. 13, lock release 71 is located within hole 73 in the top of gate 30. The center axis of hole 73 is approximately perpendicular to the longitudinal axis of gate 30, and intersects the center axio of hole 42. Sufficient clearance is provided between hole 73 and lock release 71 so that lock release 71 can move axially within hole 75 without binding.

Lock release 71 is retained within hole 75 by spring 40 at one end; and by indenting or peening outside corner 75 (see FIG. 13) to provide an interference fit that allows only a part of lock release 71 to protrude beyond the top surface of gate 30. Lock release 71 is preferably a rigid sphere fabricated of a corrosion resistant material, for example a type 316 stainless steel ball bearing. Alternately, lock release 71 can be a short cylindrical shape, or the like, for example a stepped cylindrical lock release 77 as shown in FIG. 23.

Referring to FIGS. 13 and 14, pin 45 is inserted through the top wall of gate 30 and extends approximately to the center of hole 42. The center axis of pin 45 is approximately perpendicular to the longitudinal axis of gate 30; and intersects the center axis of hole 42. Pin 45 is firmly attached to gate 30 by press-fit, welding, bonding, or the like. Pin 45 is preferably a hard, rigid, corrosion resistant material, for example a type 316 stainless steel rivet.

Referring again to FIGS. 13 and 14, the length of pin 45 is adjusted so that pin end 47 just barely passes through hole 63 in link 61. Sufficient clearance is provided between hole 63 and pin 45 so that pin 45 can slip in and out of hole 63 without binding. When pin 45 is engaged with hole 63, movement of gate 30 is impossible because movement of link 61, and subsequent compression of spring 40, is blocked. Without the movement of link 61, gate 30 cannot open.

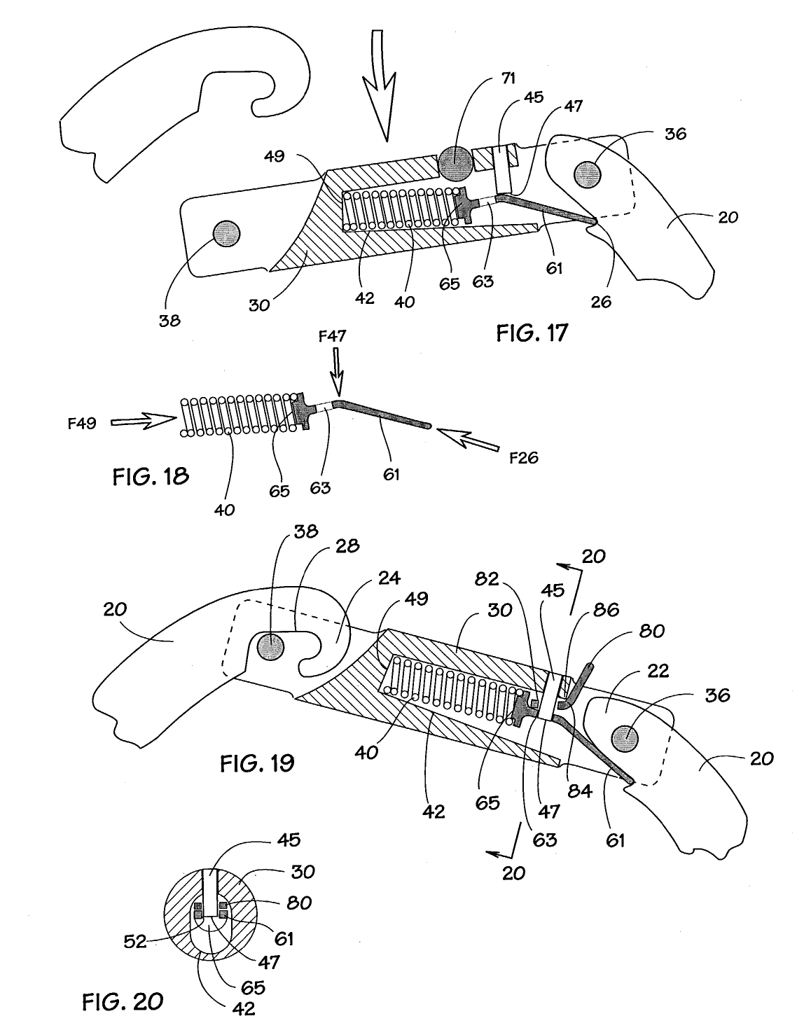

FIG. 16 shows lock release 71 pushed inward (the force pushing lock release 71 inward is depicted by the outline arrow). Inward movement of lock release 71 forces spring 40, and link 61 with it, to the other side of the oblong cross section of hole 42. Consequently, end 47 of pin 45 is disengaged from hole 63, freeing link 61 to move, and therefore gate 30 can be opened as shown in FIG. 17 (the outline arrow depicts the force opening gate 30.) Note that after gate 30 opens a small amount, hole 63 no longer lines up with pin 45 and consequently the force applied against lock release 71 is no longer needed.

FIG. 18 is a free-body diagram of spring 40 and link 61 showing the forces acting on the assembly. F49 is the force against spring 60 from end 49 of hole 42. F26 is the force against link 61 from notch 26 on body 20. Because the forces F49 and F26 are offset, joint 65 between spring 40 and link 61 will buckle upward, which is resisted by force F47 from end 47 of pin 45.

The force of spring 40 against link 61 urges gate 30 to return to the closed position. When gate 30 returns to the closed position, the buckling force will automatically move joint 65 upward as soon as hole 63 lines-up with pin 45, reengaging pin 45 with hole 63, which immediately blocks the opening movement of gate 30.

As described supra, when link 61 is at the locked position, gate 30 cannot move because. pin 45 engages hole 63, which blocks movement of link 61. For this configuration to be assembled and function properly, manufacturing tolerances must be controlled so that hole 63 lines-up with pin 45 when gate 30 is closed. Referring to FIG. 23, the distance D61 on link 61 between hole 63 and its end adjacent notch 26 must equal the distance between pin end 47 and notch 26 when gate 30 is closed. If link 61 is fabricated so that D61 is too short, some opening movement of gate 30 will occur even when pin 45 and hole 65 are engaged. Conversely, if D61 is fabricated overlong, it may not be possible to properly assemble the carabiner. These problems are avoided by the alternate inventive carabiner configuration of FIG. 23.

Referring to FIG. 23, setscrew 90 provides the means to adjust for dimensional variations of the various components. Setscrew 90 is threaded at an angle into body 20 adjacent the proper location of notch 26. The angle of the central axis of the thread is chosen so that the intersection of the surface of body 20 with the tip of setscrew 90 forms a notch for link 61. Setscrew 90 has slot 92, or the like, to facilitate adjustment. By adjusting setscrew 90 in or out, the location of notch 26 will move so that it is possible to precisely locate notch 26 with respect to dimension D61.

The use of standard off-the-shelf components will lower manufacturing costs. Costs are kept low when fabricating the alternate configuration shown in FIGS. 13-17 by using a standard ball bearing for lock release 71, and a standard rivet for pin 45, However, lock release 71 requires that hole 73 be machined in the side wall of gate 30. FIGS. 19-22 shows another alternate configuration of the instant invention that eliminates the need for hole 73.

Referring to FIGS. 19-22, lock release 80 is an approximately L-shaped bracket having hole 82 in one leg. As best seen in FIGS. 19 and 20, the holed leg of lock release 80 is positioned in hole 42 between link 61 and the wall of gate 30. Pin 45 loosely passes through hole 82. The other leg of lock release 80 protrudes outward from slot 32 adjacent lee end 22 of body 20. The engagement of hole 82 with pin 45 holds lock release 80 at its proper location. Lock release 80 is typically fabricated by stamping and bending a corrosion resistant, rigid flat material, for example 316 stainless steel strip stock.

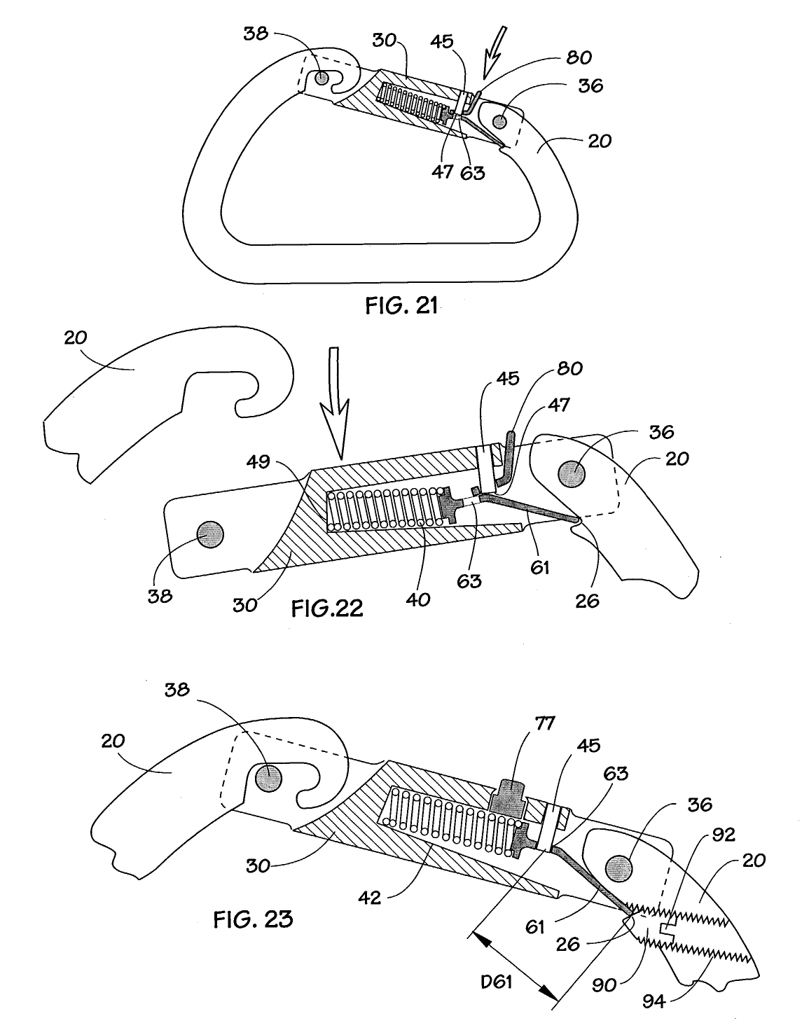

FIGS. 21 and 22 show lock release 80 pushed inward (the force pushing lock release 80 inward is depicted by the outline arrow in FIG. 21.) Inward movement of lock release 80 forces link 61 to the other side of the oblong cross section of hole 42, which disengages end 47 of pin 45 from hole 63, With link 61 free to move, gate 30 can be opened as shown in FIG. 22 (the outline arrow depicts the force opening gate 30.) Note that after gate 30 moves a small amount, hole 63 no longer lines up with pin 45 and consequently the force applied against lock release 80 is no longer needed.

The function and operation of the configuration of FIGS. 19-22 is the same as the function and operation of the configuration of FIGS. 13-18. The only difference is lock release 71 and associated hole 73 have been replaced with lock release 80, which does not require hole 73 because it is located in the gap between the hinge of gate 30 and body 20.

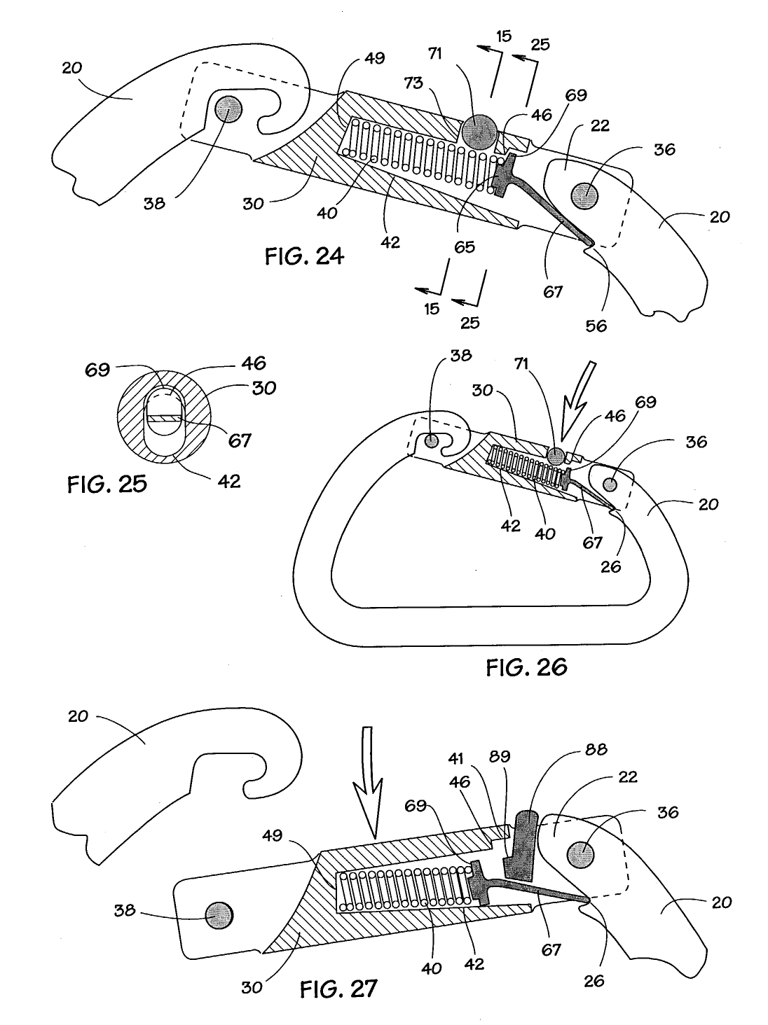

FIGS. 24-27 show yet another alternate configuration of the instant invention that eliminates the need for pin 45. Referring to FIGS. 24 and 25, shelf 46 is cut into the opening of hole 42. Shelf 46 serves the same function as pin 45. Extension 69 of link 67 extends upward a sufficient distance to engage shelf 46 when gate 30 is closed. Movement of link 67 is blocked when extension 69 engages shelf 46,

FIG. 26 shows lock release 71 pushed inward (the force pushing lock release 71 inward is depicted by the outline arrow). Inward movement of lock release 71 forces spring 40, and link 67 with it, to the other side of the oblong cross section of hole 42. Consequently, extension 69 of link 67 is disengaged from shelf 46, freeing link 67 to move, and therefore gate 30 can be opened as shown in FIG. 27 (the outline arrow depicts the force opening gate 30.) Note that after gate 30 opens a small amount, extension 69 no longer lines up with shelf 46 and consequently the force applied against lock release 71 is no longer needed.

Referring again to FIG. 27, another configuration of the instant invention replaces lock release 71 with lock release 88. Lock release 88 is a stubby L-shaped member located adjacent leg 22 of body 20. Lock release 88 is held adjacent leg 22 by shoulder 89, which will abut against wall 41 should lock release 88 attempt to escape outward. Lock release 88 functions similarly to lock release 80. Lock release 88 is fabricated from a lightweight, rigid material, for example aluminum alloy type 6061.

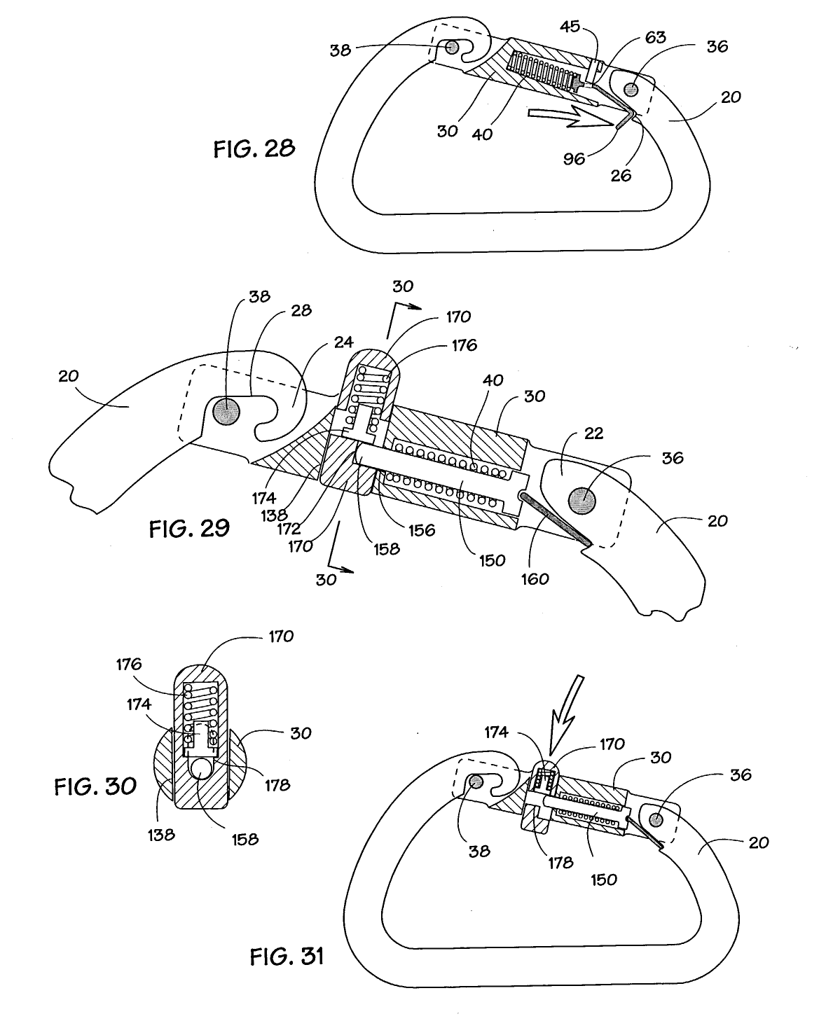

FIG. 28 shows yet another configuration of the instant invention that eliminates the need for a separate lock release component. Link 61 has L-shaped leg 96 extending downward from notch 26 under hinge pin 36. When leg 96 is pushed sideways (depicted by the outline arrow) go shown in FIG. 28, link 61 pivots around notch 26 and hole 63 disengages from pin 45. The arrangement of FIG. 29 can be applied to the configurations of FIG. 24 as well.

In contrast to the configuration of FIG. 4, which has two stable positions: locked or unlocked, the configurations illustrated by FIGS. 13-28 are always locked unless the release component is being pushed. Furthermore, the configurations illustrated by FIGS. 13-28 automatically lock as soon as gate 30 closes. However, as illustrated by FIG. 40, a climber can simultaneously unlock and open gate 30 with one hand. In FIG. 40, gate 30 is shown being pinched between the thumb and index finger so that the lock release is depressed (in FIG. 40, the force that moves the lock release is depicted by an outline arrow) thereby unlocking and opening gate 30.

FIGS. 29-32 show yet another alternate configuration of the instant invention. Referring to FIG. 29, compression spring 40 and pin 150 are loosely contained within gate 30. Compression spring 40 in conjunction with pin 150 and link 160 applies a force against body 20 adjacent but off-set inward from the center of hinge pin 36, thereby holding gate 30 closed.

As best seen in FIGS. 29 and 30, gate 30 is transversed by hole 138. The size of hole 138 is chosen so that the strength of gate 30 is not compromised. Locking member 170 is carried by gate 30 in hole 138. Sufficient clearance is provided between hole 138 and member 170 so that member 170 can move axially within hole 138 without binding.

Referring to FIG. 30, at the intersection of pin 150 with locking member 170, member 170 is transversed by elongated slot 178. Slot 178 allows end 158 of pin 150 to extend into member 170. Fin 150 in conjunction with slot 178 limits the axial movement of member 170 within hole 138.

End 158 of pin 150 abuts against surface 172 within slot 178 of member 170 when member 170 is in the locked position as shown by FIG. 29. Member 170 is maintained in the upright or locked position by spring 176 pushing the face of piston 174 against end 158 of pin 150. Piston 174 and compression spring 176 are loosely contained within locking member 170.

During the course of opening gate 30, link 160 pushes against and consequently moves pin 150 toward locking member 170. The movement of pin 150 compresses spring 40. The countering force of spring 40 against pin 150, and subsequently link 160, urges gate 30 to return to the closed position.

FIG. 29 pictures the inventive carabiner when it is locked. When the inventive carabiner is locked, gate 30 is prevented from pivoting around pin 26 because the abutment of pin end 158 against surface 172 of member 170 blocks movement of pin 150. Without the movement of pin 150, gate 30 cannot open.

Referring to FIG. 31, when a force is applied to member 170 in the direction of the outline arrow, member 170 will move relative to gate 30 to the position depicted in FIG. 31. Movement of member 170 compresses spring 176 against piston 174, which bears against end 158 of pin 150.

Preferably, pushing member 170 will first move it to the unlocked position and continued force will subsequently open gate 30. This sequence is accomplished by sizing spring 176 so that its compressive force is overcome before the closing force of spring 40 is overcome. Conversely, if an opening force is applied to gate 30 before member 170 moves to the unlocked position, end 158 of pin 150 will be jammed against surface 172 of member 170. When end 158 of pin 150 is jammed against surface 172 of member 170, member 170 will be unable to move to the unlocked position.

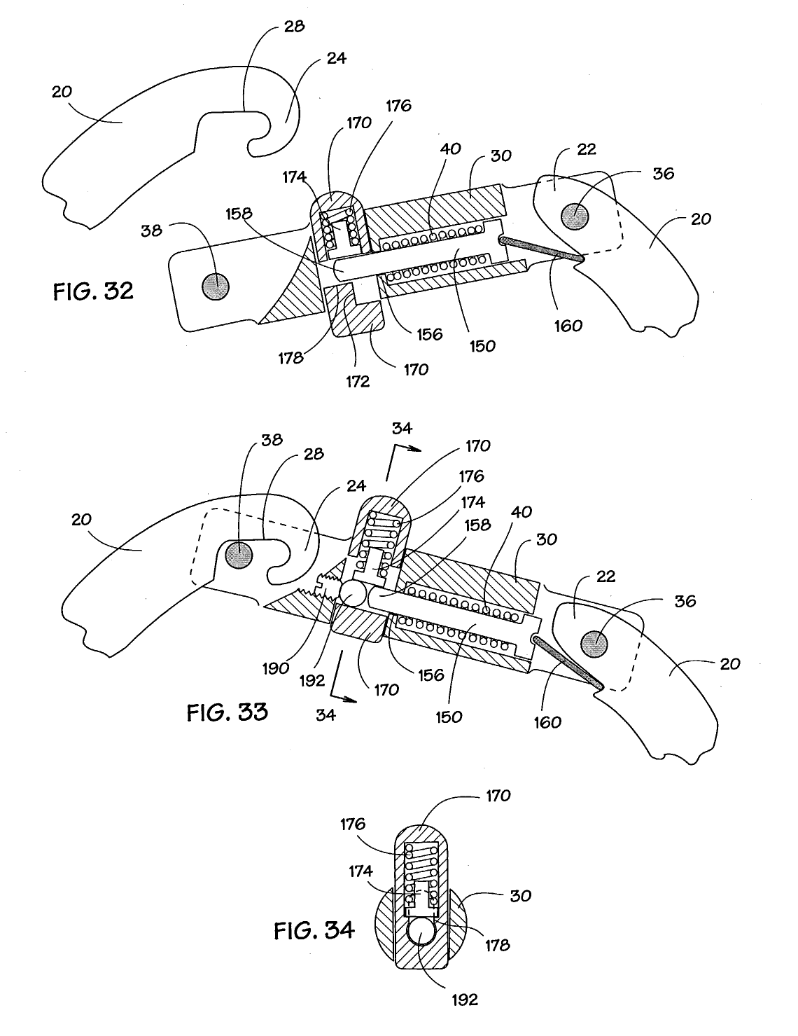

Movement of member 170 to the unlocked position shown in FIG. 31 moves surface 172 away from end 158 of pin 150, freeing pin 150 for axial movement. Continued force against member 170 or gate 30 in the direction of the outline arrow of FIG. 31 will cause pin 150 to slide further into slot 178 of member 170, thereby opening gate 30. FIG. 32 is a close-up view of the relationship of the various components when the gate is opening.

As described supra, when member 170 is at the locked position, gate 30 cannot move because member 170 blocks movement of pin 150 and consequently link 160. For this configuration to be assembled and function properly, manufacturing tolerances must be tightly controlled. For example, if one or more of the components are too short and there is a gap between end 158 and surface 172, excessive opening movement of gate 30 will occur even when locking member 170 is at the locked position. Conversely, if any one of the components is fabricated oversize, it may not be possible to properly assemble the carabiner. These problems are avoided by the alternate inventive carabiner configuration of FIG. 33.

The alternate inventive carabiner configuration of FIG. 33 incorporates setscrew 190 and ball 192. Setscrew 190 is threaded to gate 30 adjacent slot 178 of member 170. Referring to FIG. 34, ball 192 is carried by member 170 within the widest part of keyhole shaped slot 178.

Ball 192 is a rigid sphere, for example a stainless steel ball bearing. Alternately, ball 192 can be replaced with a short cylindrical pin, or the like. Ball 192 serves as a link between setscrew 190 and end 158 of pin 150.

End 158 of pin 150 abuts against ball 192 when member 170 is at the locked position. Member 170 is maintained in the upright or locked position by spring 174 pushing the face of piston 174 against end 158 of pin 150.

Ball 192 abuts against the end of setscrew 190. Ball 192 serves the same function as face 172 of the configuration depicted by FIG. 29. Setscrew 190 can be adjusted to compensate for dimensional variations of the various carabiner components. During assembly of the inventive carabiner, setscrew 190 is backed out to provide clearance between the components. After the inventive carabiner is assembled, setscrew 190 is threaded inward, pushing ball 192 until it just makes contact with end 158 of pin 150. At the point when ball 192 just makes contact with end 158 of pin 150, gate 30 will be unable to open unless member 170 is moved to the unlocked position.

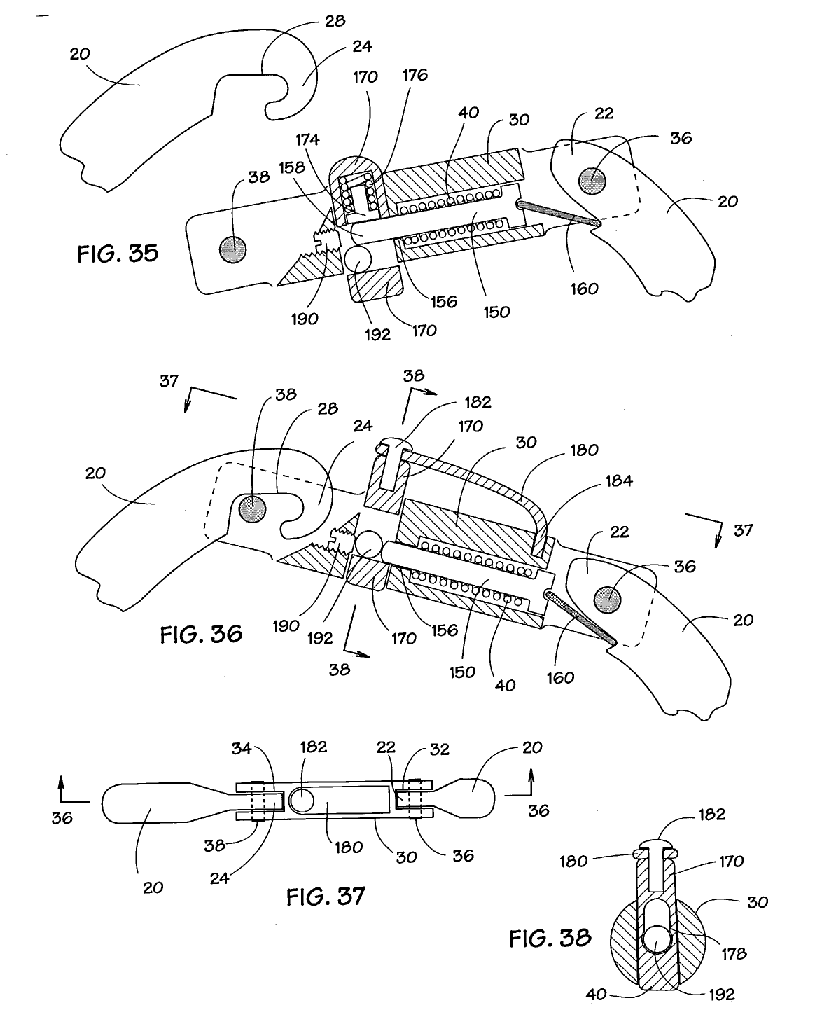

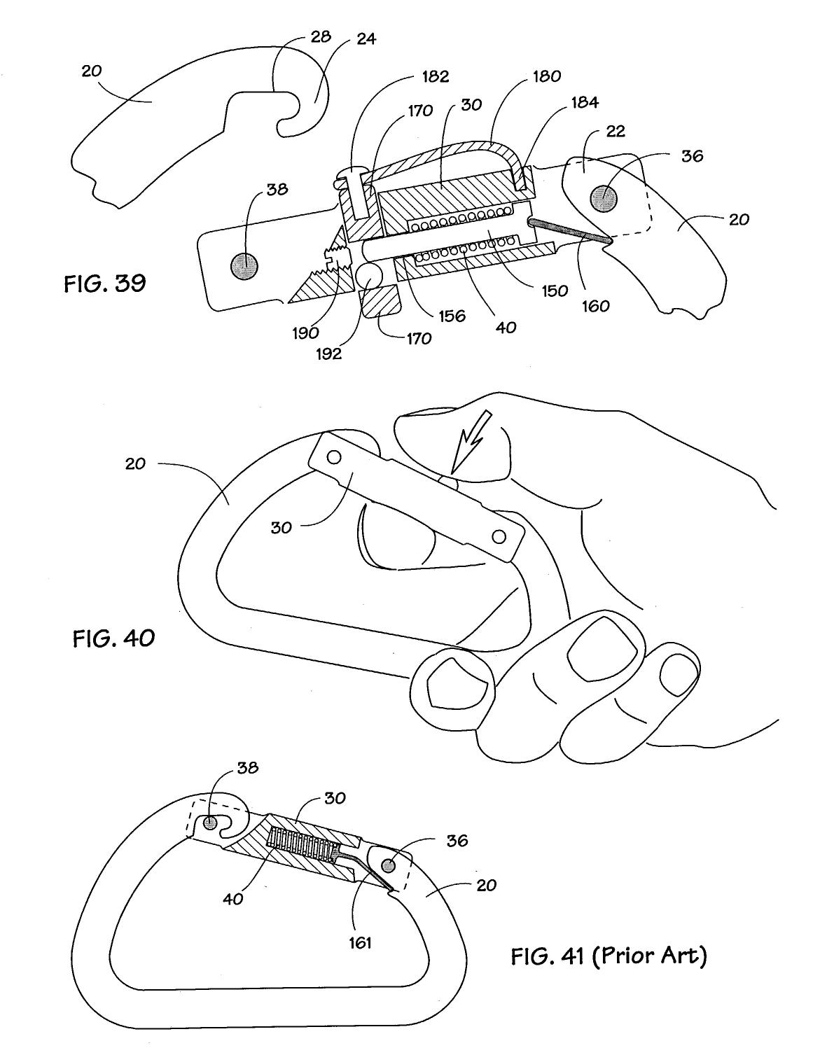

Referring to FIG. 35, locking member 170 is shown at the unlocked position; therefore ball 192 is no longer located between setscrew 190 a end 158 of pin 150. As a consequence of the opening movement of gate 30, pin 150 has moved into the space formally occupied by ball 192.

FIG. 36 shows another alternate configuration of the inventive carabiner. Cantilever spring 180, located on top of and external to gate 30, replaces internal spring 176 and piston 174. As best seen in FIGS. 36 and 37, cantilever spring 180 is fabricated from rectangular spring stock, or alternately, can be formed or molded from plastic, for example nylon.

Cantilever spring 180 is firmly attached at end 184 to gate 30. The other end of cantilever spring 180 is loosely attached to member 170 by rivet 182. Loose attachment of cantilever spring 180 to member 170 is preferable to prevent binding when member 170 moves. Alternately, rivet 182 can be a screw, or-the-like, or can be a peened extension of member 170.

Referring to FIG. 38, ball 192 is carried by member 170 within the widest part of keyhole shaped slot 178. Referring to FIG. 36, setscrew 190 provides the means to adjust for dimensional variations of the various components as described supra.

The incorporation of cantilever spring 180 eliminates the need for a cavity in member 170 to house spring 176 and piston 174. Consequently, member 170 is less costly to fabricate and, also, can have a smaller cross-section. Furthermore, unlocking and opening the inventive cgrabiner with a single finger or a rope is facilitated because member 170 can be pushed to the unlocked position by applying force, not only to the protruding end of member 170 but also by applying force anywhere along the exposed surface of cantilever spring 180.

FIG. 41 is a partial cross section of a typical prior art, non-locking carabiner. A comparison of the preferred inventive configuration of FIG. 4 with FIG. 41 will reveal that only two (2) additional components are needed to convert the prior art. A conversion to the preferred inventive locking configuration requires the addition of lock release 70 and spring pin 50, both of which are easy to fabricate. With respect to fabricating gate 30 to accommodate the added components, hole 42 must be elongated. Because the gate return spring provides the force that, in addition to closing the gate, holds the inventive locking mechanism either in the locked or unlocked states, the new components and accompanying modifications can be incorporated with little addition to the manufacturing cost of a basic carabiner. Consequently, a carabiner incorporating the preferred inventive locking mechanism can be sold for a relatively small price increase over the cost of a non-locking version.

The FIGS. illustrate, a number of inventive locking configurations, all of which have several characteristics in common: all are contained within the carabiner gate, all function by blocking the opening movement of the gate return spring mechanism, and all are controlled by an unobtrusive button, or-the-like, which protrudes from the gate.

Other variations on the shape and/or relative locations of the carabiner body, gate, spring, linkage and lock release are contemplated. It is understood that those skilled in the art may conceive of modifications and/or changes to the invention described above. Any such modifications or changes that fall within the purview of the description are intended to be included therein as well. This description is intended to be illustrative and is not intended to be limitative. The scope of the invention is limited only by the scope of the claims appended hereto.

I claim:

1. A carabiner comprising:
An oblong ring having a hinged gate adapted to insert climbing aids;
forcing means for closing said gate;
locking means substantially contained within said gate for holding said gate closed; and
operating means for activating and deactivating said locking means.

2. The carabiner recited in claim 1 wherein:
said locking means has a first position and a second position; said first position prevents opening movement of said gate; said second position allows opening movement of said gate; said operating means selectively moves said locking means from one position to the other.

3. The carabiner recited in claim 1 wherein:
said locking means has a first position and a second position; said first position blocks movement of said forcing means; said second position allows movement of said forcing means; said operating means selectively moves said locking means from said first position to said second position.

4. The locking means recited in claim 3 wherein:
said first position is stable and said second position is stable, said stability is provided by said forcing means.

5. The carabiner recited in claim 1 wherein:
A portion of said gate is hollow, said locking means and said forcing means are contained within the hollow portion of said gate; and said operating means can be manually operated external to said gate.

6. A climbing aid comprising:
a C-shaped body having a first leg end and a second leg end;
an arm adapted to span the distance between said body first and second leg ends; said arm having a first end and a second end;
said arm first end hinged to said body first leg end;
forcing means inside said arm for urging said arm second end to join said body second leg end;
control means substantially contained within said arm for selectively preventing the separation of said arm second end from said body second leg end; and
operating means for selectively deactivating said control means.

7. The climbing aid recited in claim 6 wherein:
said control means has a first position and a second position; said first position blocks movement of said forcing means when said arm second end is joined to said body second leg; said second position allows movement of said forcing means; said operating means functions to change said control means from one position to the other position.

8. A substantially oblong ring having a hinged gate adapted to provide a direct path to the inside of said ring; said gate comprising:
forcing means for closing said gate, said forcing means contained within a hollow portion of said gate;
locking means for keeping said gate closed, said locking means contained within said hollow portion of said gate;
said locking means functions by blocking opening movement of said forcing means; and
operating means for selectively activating said locking means.
